(19) United States
(12) Patent Application Publication
(10) Pub. No.: US 2025/0337093 A1
(43) Pub. Date: Oct. 30, 2025

(54) CELL CASING FOR A BATTERY CELL BODY

(71) Applicant: Hoerbiger Antriebstechnik Holding GmbH, Schongau (DE)

(72) Inventors: Christian REUMÜLLER, Schongau (DE); Martin Sedlmair, Schongau (DE)

(21) Appl. No.: 19/182,848

(22) Filed: Apr. 18, 2025

(30) Foreign Application Priority Data
Apr. 24, 2024 (DE) 102024111496.7

(51) Int. Cl. H01M 50/342

(52) U.S. Cl. CPC H01M 50/3425; H01M 2200/20

(57) ABSTRACT

A cell casing for a battery cell body has side walls and a bursting device which is arranged on one of the side walls. The bursting device is formed from an insert element and a bursting membrane. The insert element has a bursting aid having a cutting geometry which is associated with the bursting membrane. The bursting aid projects in the direction of the bursting membrane beyond a plane defined by the insert element.

The present disclosure relates to a cell casing for a battery cell body, which has side walls and a bursting device arranged on one of the side walls.

### BACKGROUND

Battery cells, also known as accumulator cells, serve to chemically store electrical energy. One of the best-known battery cells is the lithium-ion battery cell.

Typically, a battery cell comprises at least one battery cell body in the form of an electrode winding or an electrode stack, which in turn is formed from at least one positive electrode, at least one negative electrode and at least one separator arranged between the positive and the negative electrode. The battery cell body may additionally have an insulating film which is wrapped around the electrode winding or electrode stack. To form a battery cell, the battery cell body is inserted into a cell casing. Depending on the design of the cell casing, the battery cell is designed in the form of a round cell, a pouch cell or a prismatic cell.

In lithium-ion batteries, gas formation and an excessive pressure resulting therefrom may occur inside the battery cell in certain situations, such as a defect or improper handling. It is therefore known to provide a pressure relief valve or a bursting membrane in the cell casing of the battery cell body to discharge the generated gases purposefully in one direction and to prevent a thermal runaway of the battery cell. The bursting membrane is designed so as to burst from a certain pressure inside the cell casing.

The cell casing of prismatic cells is usually made of aluminum or a material containing an aluminum alloy, and the bursting membrane is directly incorporated into the aluminum cell casing. The bursting membrane is therefore also made of aluminum or a material containing an aluminum alloy. Bursting membranes made of aluminum materials usually have a predetermined breaking point which is subjected to tensile stress or shearing forces and fails in a controlled manner when the tensile strength of the aluminum material is reached, so that the bursting membrane bursts in a controlled manner and pressure equalization can take place between the interior and the exterior of the battery cell.

Alternatively, a cell casing of a prismatic battery cell may also be made of a ferrous material, i.e. iron or a material containing an iron alloy. If the bursting membrane is then placed in the cell casing, it consists of iron or a material containing an iron alloy, like the cell casing. However, iron has a significantly higher tensile strength than aluminum, so that a bursting membrane made of iron or with an iron alloy also has a significantly higher tensile strength than a comparable bursting membrane made of aluminum or a material containing an aluminum alloy. Consequently, a bursting membrane made of iron does not burst at all, or at least not as quickly and reliably as a comparable bursting membrane made of aluminum. A bursting membrane which is directly incorporated or integrated into a cell casing made of iron or a material containing an iron alloy, i.e. is designed integrally therewith, is difficult to implement technically and economically due to the properties of iron. Therefore, in cell casings made of iron, bursting membranes are typically inserted as separate components into the cell casing.

The object of the present invention is to provide a cell casing having a bursting device which overcomes the disadvantages known from the prior art and ensures reliable bursting of the bursting membrane.

### SUMMARY

According to example embodiments, the object is achieved by a cell casing for a battery cell body, comprising side walls and a bursting device arranged on one of the side walls. The bursting device is formed from an insert element and a bursting membrane. The insert element has a bursting aid having a cutting geometry which is associated with the bursting membrane. The bursting aid projects in the direction of the bursting membrane beyond a plane defined by the insert element. Preferably, the cell casing is designed for prismatic battery cell bodies, both the cell casing and the bursting membrane being made of iron or a material containing an iron alloy.

The basic idea of example embodiments is to structurally weaken the bursting membrane of a bursting device made of iron or with an iron alloy by means of a bursting aid having a cutting geometry in the event of bursting such that the bursting membrane reliably bursts at an opening pressure between 2 and 30 bar. The bursting membrane according to the invention does not burst due to a predetermined breaking point subjected to tensile stress or shearing forces, as is possible with a bursting membrane made of aluminum, but due to a stability failure of the bursting membrane itself. A predetermined breaking point is not absolutely necessary. With the aid of the multi-part bursting device according to the invention, it is therefore possible to manufacture a bursting membrane, such as the cell casing, from iron or a material containing an iron alloy and to achieve a safe and reliable bursting at a desired opening pressure. The bursting membrane may thus be integrated into the cell casing made of iron or containing an iron alloy, i.e. formed integrally therewith. It does not have to be designed as a separate component, which, among other things, reduces the manufacturing costs of the cell casing.

The bursting membrane extends towards the inside of the cell casing. It is therefore not in the same plane as one of the side walls. This ensures that the bursting membrane is at a distance from the bursting aid.

The insert element is a separately designed component that is placed on the cell casing and attached to it. The insert element does not penetrate the cell casing. This means that the cell casing does not need to have an opening for the insert element and can be closed. This has the advantage that the stability and tightness of the cell casing remain guaranteed. The insert element is therefore subsequently attached to the outside of the cell casing in the area of the bursting membrane and then connected to the cell casing. The insert element does not extend into the cell casing or the inside of the cell. This means that the bursting membrane is not clamped between two parts of the insert element.

According to example embodiments, the bursting membrane only comes into contact with the bursting aid in the event of bursting at a pressure between 2 and 30 bar inside the cell casing, or only rests against the bursting aid in the event of bursting, so that the bursting membrane is only structurally weakened if there is actually a bursting event. At a pressure below 2 bar, the bursting membrane and the bursting aid are spaced apart to prevent the bursting membrane from being damaged by the cutting geometry of the bursting aid, which is bent in the direction of the bursting membrane.

According to one aspect of example embodiments, the insert element is a flat, frame-like plate having an internal opening, the bursting membrane being supported on the plate around the opening. The edge of the internal opening in particular has the shape of a superellipse or an oval with two straight, parallel sections and two opposing curved sections.

The insert element thus has substantially two functions. Firstly, it provides the bursting aid and ensures that the bursting aid is arranged in such a position and at such a distance from the bursting membrane that a reliable and safe bursting of the bursting membrane is ensured at a point provided for that purpose. The insert element thus favors reliable triggering of the bursting membrane. On the other hand, the insert element provides a supporting surface for the bursting membrane and thus limits on the one hand the expansion of the opening of the bursting membrane in the event of bursting and, on the other hand, stabilizes the cell casing after an event of bursting. The insert element is designed to prevent the bursting membrane from tearing open in an uncontrolled manner and, if necessary, to prevent the side walls of the cell casing from being unintentionally damaged by the bursting membrane tearing open in the event of bursting. The opening area of the bursting element in the event of bursting is 20 to 5,000 mm². Conversely, this means that the internal opening of the insert element has a size of at least 20 to 5,000 mm².

According to a further aspect of example embodiments, the bursting aid is formed integrally with the insert element at the edge of the opening. In other words, the bursting aid emerges from the edge of the opening of the insert element. This ensures that there are no connecting points between the bursting aid and the insert element which could represent an unwanted predetermined breaking point and which, in the worst case, could lead to the bursting membrane coming to rest against the bursting aid but not breaking, but instead the connecting point between the bursting aid and the insert element detaching and the bursting aid breaking off without the bursting membrane bursting.

According to example embodiments, the bursting aid may have a tip which, in a plan view, is located within the opening of the insert element. In other words, the bursting aid projects into the opening of the insert element. This results in the bursting membrane not contacting the bursting aid at a supporting area where the bursting membrane is permanently supported on the insert element, but in a contact taking place between the bursting membrane and the bursting aid a little further inside the opening and spaced apart from the supporting area of the bursting membrane.

Due to the tip of the bursting aid and the fact that the bursting aid projects in the direction of the bursting membrane beyond a plane defined by the insert element, the bursting aid has the shape of a shark fin in a plan view, which extends from the edge of the opening in the direction of the opening of the insert element. The bursting aid is not symmetrical.

The bursting aid is a section of material which is formed integrally with the insert element and is pulled out of the plane of the insert element. As a result, the bursting aid has a trapezoidal or even triangular cross-section, which forms the cutting geometry at least on the surface or edge or tip thereof facing the inside of the opening. The bursting aid and the insert element enclose an angle between them which is smaller than 180°.

According to a further aspect of example embodiments, the insert element is formed as a separate component which is connected to the cell casing at a connecting interface by an intermaterial bond and/or in a form-fitting manner. In particular, the insert element is firmly connected to the cell casing by a joining process by intermaterial bond and/or in a form-fitting manner. This ensures that the insert element does not detach from the cell casing in the event of bursting. The connection of the insert element to the cell casing by an intermaterial bond and/or in a form-fitting manner also allows the insert element to serve as a reinforcement of the cell casing in the area of the bursting device and to give the cell casing additional stability.

According to example embodiments, it may be provided that the cutting geometry of the bursting aid of the insert element is a cutting edge, a cutting surface and/or a tip. The cutting geometry is arranged such that, in the event of bursting, the bursting membrane first comes into contact with the cutting geometry of the bursting aid, the bursting of the bursting membrane being caused on contact with the cutting geometry. Advantageously, the cutting geometry is the first and, in particular, the only part of the bursting aid to come into contact with the bursting membrane shortly before and/or during the bursting thereof.

According to a further aspect of example embodiments, the bursting membrane is formed integrally with the cell casing. In this way, the introduction of a connecting point between the bursting membrane and the cell casing, which weakens the stability of the cell casing and, in the worst case, represents an unwanted predetermined breaking point, may be avoided. Rather, the bursting membrane is part of a side wall of the cell casing, i.e. it is formed from the side wall itself, so that there is no connecting point between the bursting membrane and the cell casing. In addition, this eliminates a processing step in the production of the cell casing, and the number of separately formed parts can be reduced. Both save time in the production of the cell casing. The bursting membrane is therefore introduced directly into the cell casing or formed from a side wall of the cell casing.

The bursting membrane has a convex side and a concave side, wherein the convex side faces towards the interior of the cell casing. In other words, part of a side wall of the cell casing is pressed towards the interior of the cell casing and thus forms the bursting membrane. This bursting membrane, produced in this way, is a reverse bursting element, the bursting of which is based on the bursting membrane bursting due to stability failure when there is increased pressure inside the cell casing. As soon as the pressure inside the cell casing rises to an opening pressure of 2 to 30 bar, the bursting membrane is pushed in the direction of the outside of the cell casing until the bursting membrane comes to rest against the bursting aid and the bursting membrane is structurally weakened by the cutting geometry so as to burst at this point of contact.

In a normal state, i.e. a state in which the pressure inside the cell casing is below 2 bar, the bursting membrane and the bursting aid are however arranged spaced apart from each other. In other words, in a normal state, the bursting membrane does not rest against the bursting aid.

According to example embodiments, the bursting membrane and the bursting aid are not arranged parallel to each other since both the bursting membrane and the bursting aid have a curvature.

According to a further aspect of example embodiments, the cell casing has a wall thickness w1 and the bursting membrane has a wall thickness w2, wherein the wall thickness w2 of the bursting membrane is less than the wall thickness w1 of the cell casing at least in an area of the bursting membrane. The area in which the bursting membrane has a wall thickness w2 smaller than the wall thickness of the cell casing w1 serves as a kind of predetermined breaking point at which the bursting membrane bursts when it comes to rest against the bursting aid. The wall thickness w1 of the cell casing is 0.1 to 2 mm. However, the wall thickness in the area of the bursting device is greater, since the wall thickness there is composed of the wall thickness w2 of the bursting membrane, which substantially corresponds to the wall thickness w1 of the cell casing at this point, and the wall thickness w3 of the insert element. The insert element has a wall thickness w3 of 0.2 to 3 mm, so that the total wall thickness in the supporting area is between 0.3 and 5 mm.

According to a further aspect of example embodiments, the insert element covers only part of a side wall of the cell casing. In particular, the cell casing has four side walls, two side walls being respectively arranged parallel opposite each other, thus forming a rectangular cross-section of the cell casing. The cell casing thus has two short sides and two long sides, which are respectively arranged opposite each other. The insert element is advantageously arranged on one of the two short sides of the cell casing and has substantially the same width as the short sides, but covers only part of the length of the short side. In particular, the insert element covers less than half of the length of the short side. However, it is of course generally possible for the insert element to cover more than half of the length and/or width of a side surface.

### BRIEF DESCRIPTION OF THE DRAWINGS

Further features and advantages of example embodiments will become apparent from the following description and the accompanying drawings, to which reference is made and in which:

FIG. 1 shows a schematic representation of a cell casing according to the invention, with a bursting device;

FIG. 2 shows a plan view of the bursting device of FIG. 1;

FIG. 3 shows an isometric side view of an insert element of the bursting device of FIG. 1; and

FIG. 4 shows a cross-sectional view along the plane A-A of the bursting device of FIG. 2, with a bursting element and a bursting membrane.

### DETAILED DESCRIPTION OF EXAMPLE EMBODIMENTS

FIG. 1 shows a cell casing 10 for a battery cell body 12, which is in particular designed as a prismatic cell casing.

The cell casing 10 has a rectangular cross-section and has two short sides formed by the two side walls 14 and two long sides formed by the two side walls 16. The four side walls 14, 16 enclose an interior 18 of the cell casing 10.

The cell casing 10 consists of a ferrous material, i.e. iron or a material comprising an iron alloy.

The cell casing 10 is produced by forming a blank or by roll-forming a metal sheet, wherein a side wall 14, 16 is bent at an angle of 90° to an adjacent side wall 16, 14, so that the bending angle between two side walls 14, 16 is always 90°. The corresponding bending radius between two side walls 14, 16 is between 0.1 and 10 mm.

The cell casing 10 in its final shape has a wall thickness w1 of 0.1 to 2 mm.

The two side walls 14 and the two side walls 16 of the cell casing 10 can have beads 20 to increase rigidity. In FIG. 1, the two side walls 14 have a plurality of beads 20 arranged parallel to each other.

The cell casing 10 has a bursting device 22, which is arranged on one of the two side walls 14. Of course, the bursting device 22 can also be arranged in one of the other side walls 14, 16.

The bursting device 22 is formed from an insert element 24 and a bursting membrane 26, the bursting membrane 26 being set up to burst in the event of bursting and to allow pressure equalization between the interior 18 of the cell casing 10 and an exterior 28 of the cell casing 10.

The insert element 24 is formed as a separate component and serves, among other things, to support the bursting membrane 26. For this purpose, the insert element 24 and the bursting membrane 26 have mutually corresponding supporting areas 27, at which the bursting membrane 26 rests against the insert element 24 and is supported. These supporting areas 27 can be seen particularly well in FIG. 4.

The insert element 24, like the cell casing 10, is formed from a ferrous material, in particular from iron or a material containing an iron alloy.

As can be seen particularly well in FIG. 1, the insert element 24 covers only part of the side wall 14. The insert element 24 extends almost completely across the side wall 14 in the transverse direction, while it covers only part of the side wall 14 in the longitudinal direction.

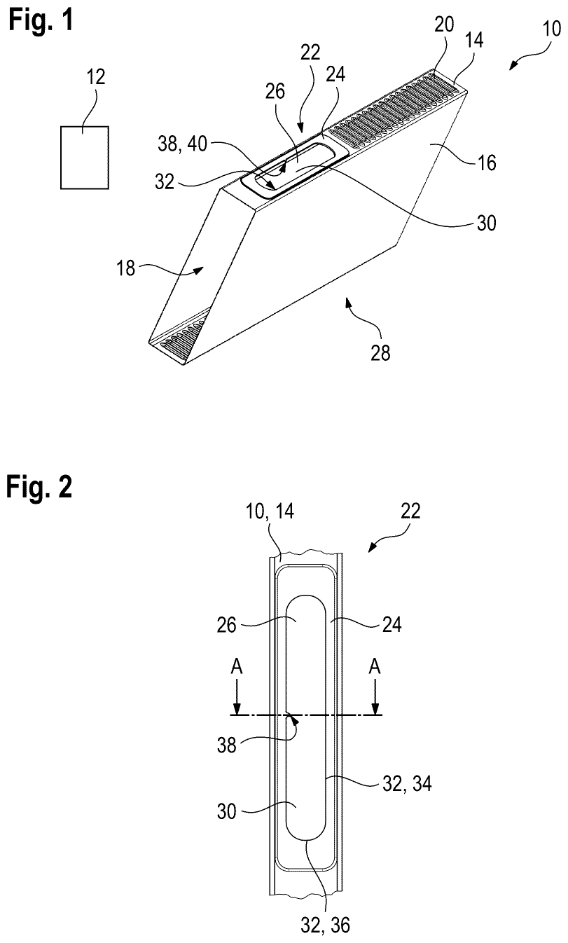

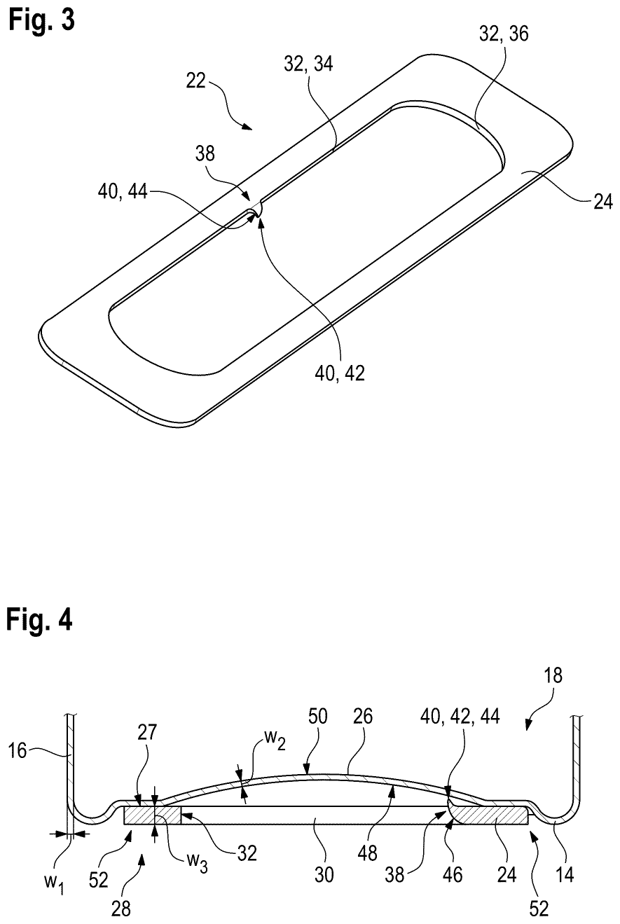

The insert element 24, which can be seen particularly well in FIGS. 2 and 3, is described in more detail below.

The insert element 24 is a flat, rectangular plate which has four rounded corners and a wall thickness w3 of 0.2 to 3 mm.

In the center of the insert element 24 is an internal opening 30, within which, in a plan view, the bursting membrane 26 is arranged. The opening 30 has an edge 32 which has a superelliptical shape or is an oval made of circular arcs and straight lines. More specifically, the edge 32 has two opposite straight sections 34 which run parallel to each other and two curved or arcuate sections 36 which are also arranged opposite each other.

The opening 30 is arranged in the center of the insert element 24, so that the insert element 24 is axially symmetrical along a longitudinal and a transverse axis.

A bursting aid 38 is formed integrally with the insert element 24 on one of the two straight sections 34 of the edge 32 of the opening 30.

The bursting aid 38 serves to cause the bursting membrane 26 to burst in the event of a bursting. The bursting aid 38 must therefore be able to structurally weaken the bursting membrane 26 such that the bursting membrane 26 breaks at least at one point, to allow a gas exchange between the interior 18 and the exterior 28 of the cell casing.

The bursting aid 38 is located substantially in the center on one of the two straight sections 34 of the edge 32 and extends from the edge 32 towards the center of the opening 30. The bursting aid 38 thus represents a kind of bulge of the edge 32 of the opening 30.

Upon examination of the cross-section of the bursting aid, as illustrated in FIG. 4, it becomes clear that the bursting aid 38 not only projects into the opening 30, but also in the direction of the bursting membrane 26 beyond a plane defined by the insert element 24. In other words, the bursting aid 38 is bent out of the plane of the insert element 24 and points, on the one hand, towards the interior 18 of the cell casing 10, i.e. towards the bursting membrane 26, and, on the other hand, towards the center of the opening 30.

This orientation and arrangement of the bursting aid 38 ensures, on the one hand, that the bursting membrane 26 is certain to come to rest against the bursting aid 38 in the event of bursting and, on the other hand, that the bursting membrane 26 is not accidentally damaged by the bursting aid 38 at an undesirable point.

To ensure reliable bursting of the bursting membrane 26, the bursting aid 38 has a cutting geometry 40 which is associated with the bursting membrane 26 and against which the bursting membrane 26 comes to rest in the event of bursting.

The cutting geometry 40 arranged on the bursting aid 38 can in principle be a cutting edge, a cutting surface and/or a tip.

The bursting aid 38 shown in FIGS. 3 and 4 has both a cutting geometry 40 designed as a tip 42 and a cutting geometry 40 designed as a cutting edge 44. Due to the cutting geometry 40 designed as a tip 42, the bursting aid 38 has a substantially triangular shape in a plan view. The shape resembles that of a shark fin.

Both the cutting edge 44 and the tip 42 are inclined in the direction of the bursting membrane 26 and thus lie outside the plane defined by the insert element 24.

Since the bursting aid 38 is formed integrally with the insert element 24 and is bent or shaped in the direction of the bursting membrane 26, the edge 32, at the point where the bursting aid 38 emerges from the insert element 24, is not perpendicular to the insert element 24, but has a bend 46. In other words, a corner of the edge 32 is missing. This bend 46 is due to the material deformation of the insert element 24 when the bursting aid 38 is formed from the insert element 24.

FIG. 4 shows the bursting device 22 of FIG. 2 in cross-section along the axis A-A. The shape of the bursting membrane 26 is particularly apparent therefrom.

The bursting membrane 26 is formed integrally with the cell casing 10 and thus constitutes part of the side wall 14 of the cell casing 10.

The bursting membrane 26 has a curved structure so that it has a convex side 48 and a concave side 50. The bursting membrane 26 is formed from the cell casing 10 such that the concave side 50 of the bursting membrane 26 points towards the interior 20 of the cell casing 10, so the bursting membrane 26 is pressed inwards.

Due to the curved shape of the bursting membrane 26, it does not come into contact with the bursting aid 38 in the normal state, as shown in FIG. 4. In the normal state, the bursting membrane 26 and the bursting aid 38 are therefore arranged spaced apart from each other.

Only in the event of a bursting, in which the pressure in the interior 18 of the cell casing 10 is in a range between 2 and 30 bar, contact occurs between the bursting membrane 26 and the bursting aid 38, or more precisely between the bursting membrane 26 and the cutting geometry 40, so that the bursting membrane 26 is structurally damaged by the cutting geometry 40 of the bursting aid 38, thus bursting and allowing pressure equalization between the interior 18 of the cell casing 10 and the exterior 28 of the cell casing 10. The opening area of the bursting membrane is between 20 and 5,000 mm².

The bursting of the bursting membrane 26 is here based on the principle of stability failure, since the bursting membrane 26 does not burst at a predetermined breaking point, but bursts where it is structurally weakened due to contact with the bursting aid 38. For this reason, the bursting membrane 26 is a reverse bursting element. It is therefore particularly important for the operating principle that the bursting membrane 26 comes to rest against the bursting aid 38 and the cutting geometry 40 thereof only in the event of bursting.

To facilitate and improve the bursting of the bursting membrane 26, the wall thickness w2 of the bursting membrane 26 is smaller than the wall thickness w1 of the cell casing, at least in an area of the bursting membrane 26. The area in which the wall thickness w2 of the bursting membrane 26 is less than the wall thickness w1 of the cell casing 10 represents a kind of predetermined breaking point of the bursting membrane 26, at which the bursting membrane 26 preferably bursts.

To give the cell casing additional stability in the area of the bursting device 22, the bursting membrane 26 is supported on the one hand on two supporting areas 27 on the insert element 24 and on the other hand, the insert element 24 is connected to the cell casing 10 by an intermaterial bond and/or in a form-fitting manner via connecting interfaces 52.

The connecting interfaces 52 are designed such that the insert element 24 is flush with the outer edge of the cell casing 10 and the insert element 24 does not project beyond the cell casing 10. In particular, the connecting interfaces 52 are designed in a stepped manner for this purpose, so that the insert element 24 can be inserted into the connecting interfaces 52. Preferably, the connecting interfaces 52 are dimensioned such that the insert element 24 not only contacts the bursting membrane 26 and thus the cell casing 10 at the supporting areas 27, but also such that contact is made with the connecting interfaces 52 of the cell casing 10 at lateral areas of the insert element 24.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A cell casing for a battery cell body, comprising:
side walls and a bursting device which is arranged on one of the side walls and is formed from an insert element and a bursting membrane,
wherein the insert element has a bursting aid having a cutting geometry which is associated with the bursting membrane, and
wherein the bursting aid projects in the direction of the bursting membrane beyond a plane defined by the insert element.

2. The cell casing of claim 1, wherein the insert element is a flat, frame-like plate having an internal opening, wherein the bursting membrane is supported on the plate around the opening.

3. The cell casing of claim 2, wherein the bursting aid is formed integrally with the insert element at the edge of the opening.

4. The cell casing of claim 3, wherein the bursting aid has a tip which, in a plan view, is located within the opening.

5. The cell casing of claim 2, wherein the bursting aid is a material section which is formed integrally with the insert element and is bent out of the plane of the insert element.

6. The cell casing of claim 1, wherein the insert element is designed as a separate component which is connected to the cell casing at a connecting interface by an inter-material bond and/or in a form-fitting manner.

7. The cell casing of claim 1, wherein the cutting geometry is a cutting edge, a cutting surface and/or a tip.

8. The cell casing of claim 1, wherein the bursting membrane is formed integrally with the cell casing.

9. The cell casing of claim 1, wherein the bursting membrane has a convex side and a concave side, wherein in particular the convex side points in the direction of the interior of the cell casing.

10. The cell casing of claim 1, wherein in a normal state, the bursting membrane and the bursting aid are arranged spaced apart from each other.

11. The cell casing of claim 1, wherein the cell casing has a wall thickness w1 and the bursting membrane has a wall thickness w2, wherein the wall thickness w2 of the bursting membrane is smaller than the wall thickness w1 of the cell casing at least in one area of the bursting membrane.

12. The cell casing of claim 1, wherein the insert element covers only part of a side wall of the cell casing.
